(19) United States
(12) Patent Application Publication
(10) Pub. No.: US 2007/0256849 A1
(43) Pub. Date: Nov. 8, 2007

(54) Mounting tab fastener support apparatus and method

(75) Inventors: Charles Wayne Ivey, Fayetteville, NC (US); Dennis W. Neibrook, Florence, SC (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Marley Engineered Products LLC

(21) Appl. No.: 11/415,222

(22) Filed: May 2, 2006

(51) Int. Cl. H01H 13/04

(52) U.S. Cl. 174/58

(57) ABSTRACT

In accordance with one embodiment of the present invention, a fastener holding bracket is provided. In some embodiments, the fastener holding bracket includes an attaching portion configured to attach the fastener holding bracket to a mounting tab; and a holding structure attached to the bracket configured to hold a fastener when the fastener is placed in the holding structure. In accordance with yet another embodiment of the present invention, a method of positioning a fastener with a mounting tab is provided. In some embodiments, the method includes aligning fastener holding structure on a fastener holding bracket to a hole on a mounting tab; and positing a fastener in the fastener holding structure.

### FIELD OF THE INVENTION

The present invention relates generally to a method and apparatus for holding a fastener in place so that the fastener may be installed. More particularly, the present invention relates to a bracket for supporting a fastener (such as a nail, screw or the like) in place so that the fastener may be installed in a mounting tab for mounting a box appliance such as a ventilation fan or light to a joist.

### BACKGROUND OF THE INVENTION

Many households and commercial appliances are installed by being fastened to ceiling joists in buildings. For example, bathroom ventilation fans, which may also include lights, are installed to a ceiling joist. The ventilation fan is often contained within a box housing. The box housing may be attached to a joist by a tab that either can be integral with the housing or connected to the housing.

These boxes may be installed in a variety of ways; however, two ways are often used. In the first method, a fastener such as a nail or screw is partially driven into a specific place at a measured distance from one of the edges of the ceiling joist. A second fastener is then partially installed the same distance from the same edge of the joist and at a measured distance from the first fastener. The box or housing is installed by placing the large openings in keyhole slots located in the mounting tabs attached to the housing over the partially driven end fasteners and dropping the box housing into place, moving the fasteners along the slot portions of the keyhole slots. The fasteners are then tightened or driven to secure the box to the joist. While this method is effective, it requires time and accurate measuring to locate the fasteners in the proper place.

In another common method of installing box appliances, the mounting holes in the mounting tab are used as a template. The installer positions the box against the side of a ceiling joist, and then marks on the joist using the mounting holes as a template to where locate the fasteners in the ceiling joist. The installer then removes the box from its place in the housing and partially installs the fasteners. Once the fasteners are partially installed where indicated on the ceiling joists, the installer then puts the box back into position placing the keyhole over the heads of the fasteners and dropping the box into place. Then the fasteners are completely driven into the joist to secure the box to the joist. Once the box is in place, additional fasteners may be used to secure the box or housing in place.

One disadvantage of this method is that the installer must set the box down in order to preinstall the nails or screws. This can be cumbersome particularly in instances, which is often the case, where the installer is working on a ladder in a dimly lit area. Therefore, a method and apparatus that will more easily allow an installer to install a box to a ceiling joist is desired.

Accordingly, it is desirable to provide a method and apparatus that provides a simple way for an installer to install a box appliance.

### SUMMARY OF THE INVENTION

The foregoing needs are met, to a great extent, by the present invention, wherein in one aspect, a method and apparatus is provided that in some embodiments a fastener securing bracket holds a fastener and locates it with respect to the mounting holes in the mounting tab so that an installer can easily install the box in a desired location along the joist.

In accordance with one embodiment of the present invention, a fastener holding bracket is provided. In some embodiments, the fastener holding bracket includes an attaching portion configured to attach the fastener holding bracket to a mounting tab; and a holding structure attached to the bracket configured to hold a fastener when the fastener is placed in the holding structure.

In accordance with another embodiment of the present invention, a fastener holding bracket is provided. In some embodiments, the fastener holding bracket includes means for attaching the fastener-holding bracket to a mounting tab; and means for holding a fastener aligned with a hole in a mounting tab.

In accordance with yet another embodiment of the present invention, a method of positioning a fastener with a mounting tab is provided. In some embodiments, the method includes aligning fastener holding structure on a fastener holding bracket to a hole on a mounting tab; and positing a fastener in the fastener holding structure.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a mounting system including a mounting tab and fastener holding bracket in an initial condition attached to a box housing in accordance with one embodiment of the invention.

FIG. 2 is a perspective view illustrating a fastener being held by the fastener holding bracket in an intermediate position and the box housing butted up against the joist in a desired location.

FIG. 3 is a perspective view of a box housing located against the joist in a desired location where two fasteners are held in place by two fastener holding brackets.

FIG. 4 is a perspective view illustrating an installed box housing where the fastener holding bracket is in a final position.

FIG. 5 is a perspective view of an alternate embodiment according to the invention where the holding bracket is separate from the mounting tab.

FIG. 6 is a cross-sectional view taken along the line 6-6 of FIG. 5.

### DETAILED DESCRIPTION

The invention will now be described with reference to the drawing figures, in which like reference numerals refer to like parts throughout. An embodiment in accordance with the present invention provides an apparatus for holding a fastener for mounting a boxed appliance such as a bathroom ventilation fan. Another embodiment, in accordance with the present invention, provides a method of holding a fastener in place for fastening an appliance such as a ventilation fan to a ceiling joist.

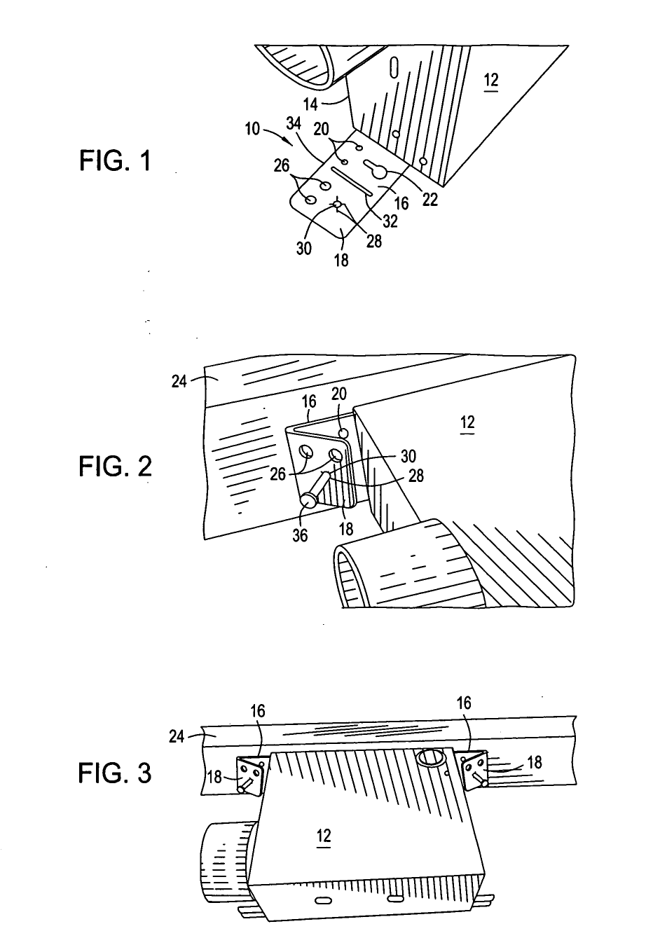

An embodiment of the present inventive apparatus is illustrated in FIG. 1. A mounting system 10 is mounted to a box 12. The box 12 includes an outer housing 14. Contained within the housing 14 is an appliance such as a ventilation fan or ventilation fan light combination. In other embodiments of the invention, other box housings may include other objects other than ventilation fans and ventilation fan light combinations.

The mounting system 10 includes a mounting tab 16. The mounting tab 16 may be integral to the housing 14 or may be attached to the housing 14. Attached to, and in some embodiments integral with, the mounting tab 16, is a fastener holding bracket 18. The mounting tab 16 includes mounting holes 20. The mounting holes 20 extend through the mounting tab 16 and are configured to permit fasteners to extend through the mounting holes 20 to fasten the mounting tabs 16 to a joist 24 (see for example, FIG. 2).

In some embodiments of the invention, a keyhole slot 22 is found in the mounting tab 16. The keyhole slot 22 permits the head of a fastener such as a nail or screw to pass through a large portion of the keyhole slot 22 and allow the narrow portion of the keyhole slot 22 to slide along a shaft portion of a fastener and allow the fastener to secure the mounting tab 16 to the joist 24.

The fastener holding bracket 18 may include fastener holding holes 26. The fastener holding holes 26 may be dimensioned so that they provide a press fit for a fastener that is placed in the fastener holding holes 26 in order to hold a fastener snug in the holes 26.

In addition, the fastener holding bracket 18 may also include fastener holding slits 28. In some embodiments of the invention, the fastener holding slits 28 are elongated slits that cross in an X shape as shown in FIG. 1. Optionally, a fastener holding opening 30 may appear where two fastener holding slits 28 intersect. A structure including fastener holding slits 28 and a fastener holding opening 30 may be useful to adapt to whatever size fastener will be used for securing the box 12 to a joist 24. Thus, the fastener holding slits 28 and fastener holding openings 30 are. adaptable for fasteners of various diameters.

In embodiments of the invention where the fastener holding bracket 18 is part of, or integral to, the mounting tab 16, as shown in FIG. 1, a flexing slot 32 may be found. The flexing slot 32 helps define a border between the mounting tab 16 and the fastener holding bracket 18. One purpose of the flexing slot 32 is to weaken the fastener holding bracket 18 and mounting tab 16 combination to facilitate bending of the fastener holding bracket 18 toward the mounting tab 16, as shown in FIGS. 2-4.

With the absence of material in the flexing slot 32, the remaining material present forms hinge portions 34. In embodiments of the invention equipped with hinge portion 34, the hinge portions 34 are considered attaching portions configured to attach the fastener mounting bracket 18 to the mounting tab 16. It is anticipated that the hinge portions 34 will be flexed when the fastener holding bracket 18 is bent over across the mounting tab 16, as shown in FIGS. 2-4. The flexing slot 32 also aids an installer to know where to bend the mounting system 10.

Turning now to FIG. 2, a box 12 is placed in the desired position against a ceiling joist 24 for mounting. The fastener holding bracket 18 is bent across the mounting tab 16. Often this is done so that the fastener holding bracket 18 and the mounting tab 16 are within about a 45-60 degree angle with respect to each other. The fastener holding holes 26 on the fastener holding tab 18 are somewhat aligned with the mounting holes 20 on the mounting tab 16.

In some embodiments of the invention, and as shown in the figures, the fastener holding slits 28 and the fastener holding opening 30 may be somewhat aligned with the keyhole slot 22 located on the mounting tab 16. The fastener 36 is placed in the fastener holding opening 30 and fastener holding slits 38 and extend through the fastener holding opening 30 and fastener holding slits 28 and extended through the keyhole slot 22 so that the tip of the fastener 36 is in contact with the joist 24. In other embodiments of the invention, fasteners 36 can extend through the fastener holding holes 26 and the mounting holes 20 so that the tip of the fastener 36 is in contact with the joist 24.

In some embodiments of the invention, and as shown in FIG. 3, a box 12 may be attached to several mounting tabs 16 with fastener locating tabs 18 for securing the box 12 to the joist 24. The fasteners 36 are held in place by the fastener holding brackets 18. The fasteners 36 can be driven into the joist 24 with a hammer in the case of the fastener 36 being a nail or with a screwdriver or any other any appropriate fastener driving tool, depending on what type of fastener is used.

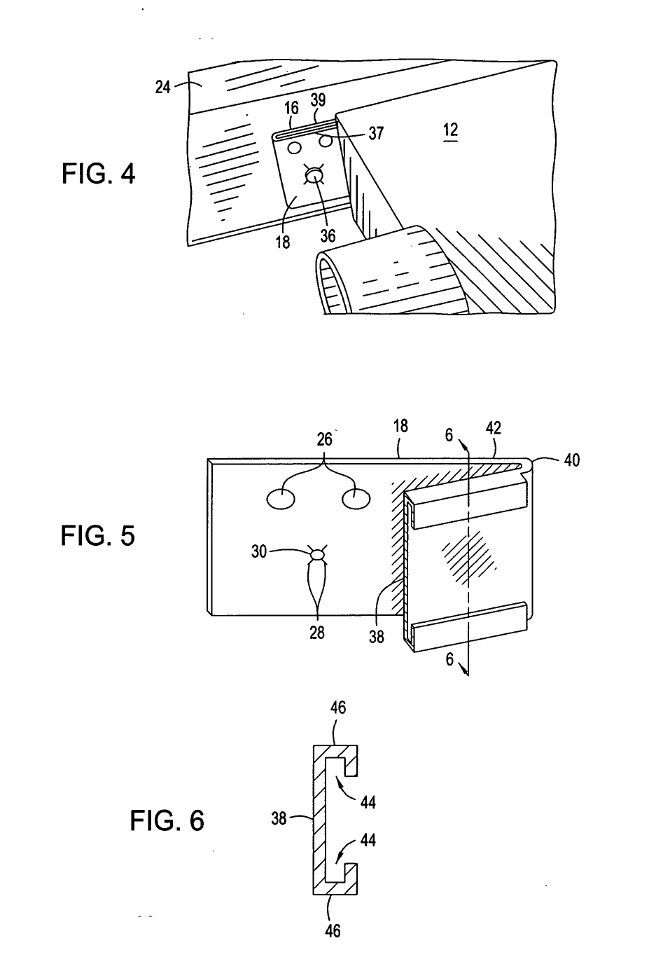

FIG. 4 shows a fastener 36 driven into the joist 24. When the fastener 36 is driven fully into the joist 24, the fastener holding bracket 18 is bent over to lay adjacent to the mounting tab 16. In some embodiments of the invention, a face 37 of the fastener holding bracket 18 may contact a face 39 of the mounting tab 16 when the fastener 36 is fully driven into the joist 24.

One advantage of some embodiments of the invention is that with the fastener 36 securing both the fastener locating tab 18 and the mounting tab 16 to the joist 24, as shown in FIG. 4, the box 12 may be more securely fastened to the joist 24. The combined thicknesses of the fastener holding bracket 18 and the mounting tab 16 are thicker than a mounting tab 16 being alone fastened to the joist 24.

Another embodiment of the invention is shown in FIGS. 5 and 6. In the embodiments shown in FIGS. 5 and 6, the fastener mounting bracket 18 is not integral to the mounting tab 16, but is rather a separate piece and attaches to a mounting tab. The separate attachable fastener mounting bracket 18 may be useful for holding fasteners 36 to mounting tab 16 that are not equipped with a fastener holding bracket 18.

The fastener holding bracket 18, shown in FIG. 5, includes fastener holding holes 26, fastener holding slits 28, which intersect each other in a X-shape, and a fastener holding opening 30. The fastener holding bracket 18 also includes a slip on portion 38 for engaging and holding the fastener holding tab 18 to a mounting tab 16. In embodiments housing a slip on portion 38, the slip on portion 38 is an attaching portion configured to attach the fastener holding bracket 18 to the mounting tab 16.

The fastener holding bracket 18, of FIG. 5, includes a flexing region 40. The flexing region 40 is located between the slip on portion 38 and the flat faced portion 42. The flat faced portion 42 includes the fastener holding holes 26 and the fastener holding slits 28 and the fastener holding opening 30. The flexing region 40 operates in a similar manner as described above for permitting the fastener holding bracket 18 to flex and bend toward the mounting tab 16 when a fastener is being installed to a joist 24.

Some embodiments of the invention may include a flexing slot 32 located in the flexing region 40 located and configured similarly to the flexing slot 32 described with respect to the embodiment described with respect to FIGS. 14.

FIG. 6 is a cross section of the fastener holding bracket 18, illustrated in FIG. 5, taken along the line 6-6. It is a cross section of the slip on portion 38. As shown in FIG. 6, the slip on portion 38 includes engaging channels 44, which are defined, at least in part, by the C-shaped sections 46. A user using a fastener holding bracket 18 of FIGS. 5 and 6 will use the slip on portion 38 to attach the fastener holding bracket 18 to a mounting tab 16. The mounting tab 16 will be inserted into the engaging channels 44 so that the fastener holding bracket 18 is in a press fit engagement with the mounting tab 16.

If the C-shaped sections 46 need to be flexed or bent to facilitate a tight hold of the fastener holding bracket 18 on to the mounting tab 16, a user can accomplish this by bending or flexing the C-shaped sections 46. The mounting tabs 16 will be inserted into the engaging channels 44 until the fastener holding holes 26 or fastener holding slits 28 and fastener holding opening 30 are somewhat aligned with the mounting holes 20 or keyhole slot 22 located in a mounting tab 16.

The flat face 42 section and the slip on portion 38 can be manufactured so that they are at an obtuse angle with respect to each other as shown in FIG. 5. In other embodiments of the invention, the slip on portion 38 and the flat face region 42 are initially substantially coplanar. In either event, a user can bend the slip on portion 38 along the flexing region 40 to achieve a desired angle between the slip on portion 38 and the flat face region 42. This bending can be done either before or after the mounting tab 16 has been inserted into the engaging channels 44, depending on the judgment of a user of the mounting system 10.

Once the fastener locating tab 18 has been flexed so that the slip on portion 38 and the flat face region 42 are at desired angles with respect to each other, and the mounting tab 16 has been inserted into the engaging channels 44 to a point where there is alignment between the fastener holding holes 26 and the mounting holes 20 or the fastener locating slots 28 the fastener holding opening 30 and a keyhole slot 22, a fastener 26 can be inserted into either the fastener holding holes 26 and extend into the mounting holes 20 and but up against a joist 24.

Alternatively, a fastener 26 can be inserted into the fastener holding opening 30, fastener holding slits 28 and extend into a keyhole slot 22 and but up against a joist 24. The fastener 36 can then be driven into the joist 24. The act of driving the fastener 36 into the joist 24 will cause additional flexing in the flexing region 40 similar to what which is described above with respect to FIG. 4.

It will be appreciated by one skilled in the art that as the face of the fastener holding bracket 37 approaches and eventually, in some embodiments, contacts the face of the mounting tab 39 that the fastener locating holding holes 26 become more and more aligned with the mounting holes 20. In addition, the fastener holding slits 28 and fastener holding opening 30 will become more and more aligned with the keyhole slot 22. These holes will become further aligned with respect to each other as the fastener 36 is driven further into the joist 24. The fact that these holes become further aligned as the fastener holding bracket 37 moves toward the mounting tab 39 is why the initial condition where the fastener is first installed these holes is described as somewhat aligned.

The somewhat alignment term is intended to describe the holes being aligned with respect to each other enough so that a fastener 36 can extend through fastener holding holes 26 into the mounting holes 20 and against the joist 24 and be driven into the joist 24. Once the fastener 36 is fully driven into the joist 24, the fastener 36 and fastener holding bracket 18 will be at or near a position where the face of the mounting tab 39 contacts or is in close proximity to the face of the fastener holding bracket 37, as shown in FIG. 4.

According to some embodiments of the invention, the fastener holding bracket 18 and/or the mounting tab 16 may be made of a variety of suitable materials. Examples of suitable materials include metal and plastic. In other embodiments of the invention, other suitable materials may be used.

Although an example of the mounting system 10 is shown in the context of a box appliance such as a ventilation fan, it will be appreciated it can be used other contexts. Also, although the mounting system 10 is useful to mount objects to joists, it can also be used in other contexts.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A fastener holding bracket comprising:
an attaching portion configured to attach the fastener holding bracket to a mounting tab; and a holding structure attached to the bracket configured to hold a fastener in position so that the fastener extends into a hole in the mounting tab when the fastener is placed in the holding structure, wherein the holding structure comprises at least one of either a hole in the fastener holding bracket and a slit in the fastener holding bracket.

2. The fastener holding bracket of claim 1, wherein the holding structure is aligned with a mounting hole on the mounting tab when the fastener holding bracket is flush against the mounting tab.

3. (canceled)

4. The fastener holding bracket of claim 3, wherein the holding structure comprises two crossed slits in the fastener holding bracket.

5. The fastener holding bracket of claim 1, wherein the holding structure is configured to hold a fastener in a key hole slot in the mounting tab.

6. The fastener holding bracket of claim 1, wherein the bracket is integral with the mounting tab.

7. The fastener holding bracket of claim 6, wherein a boundary between the mounting tab and the bracket is defined at least in part by a slot.

8. The fastener holding bracket of claim 1, further comprising multiple holding structures each configured to align a fastener with a mounting hole on the mounting tab.

9. The fastener holding bracket of claim 1, wherein the mounting tab is at least one of: metal and plastic.

10. The fastener holding bracket of claim 1, wherein the mounting tab and the fastener holding bracket fit flush which each other when the fastener is fully installed in the mounting tab.

11. The fastener holding bracket of claim 1, wherein the fastener holding bracket is a separate piece from the mounting tab.

12. The fastener holding bracket of claim 11, wherein the fastener holding bracket is configured to attach to the mounting tab.

13. The fastener holding bracket of claim 12, further comprising engaging slots on the fastener holding bracket to engage and secure the fastener holding bracket to the mounting tab.

14. The fastener holding bracket of claim 13, wherein the attaching portion has a C shaped cross section.

15. The fastener holding bracket of claim 1, further comprising a housing containing an appliance attached to the fastener bracket via the mounting tab.

16. A fastener holding bracket comprising:
means for attaching the fastener holding bracket to a mounting tab; and
means for holding a fastener in a press fit manner, the means for holding a fastener located on a holding bracket so that the fastener is held in position to be aligned with a hole in a mounting tab.

17. A method of positioning a fastener comprising:
aligning fastener holding structure on a fastener holding bracket to a hole on a mounting tab; and
positioning a fastener in the fastener holding structure and in the hole on the mounting tab.

18. The method of claim 17, wherein the aligning step includes bending a fastener holding bracket.

19. The method of claim 17, wherein the aligning step includes attaching a fastener holding bracket to the mounting tab.

20. The method of claim 17, further comprising moving the fastener holding bracket to a position flush against the mounting tab by moving the fastener to a securing position.
